(19) United States
(12) Patent Application Publication
(10) Pub. No.: US 2022/0076161 A1
(43) Pub. Date: Mar. 10, 2022

(54) COMPUTER SYSTEM AND INFORMATION PROCESSING METHOD

(71) Applicant: Hitachi, Ltd., Tokyo (JP)

(72) Inventor: Shintaro TAKADA, Tokyo (JP)

(21) Appl. No.: 17/192,057

(22) Filed: Mar. 4, 2021

(30) Foreign Application Priority Data
Sep. 8, 2020 (JP) 2020-150553

(51) Int. Cl. G06N 20/00; G06F 7/48

(52) U.S. Cl. CPC G06N 20/00; G06F 7/48

(57) ABSTRACT

The prediction accuracy of prediction models generated by ensemble learning is enhanced. A computer system configured to generate a prediction model for predicting an event includes: a storage unit configured to store a plurality of training data including a plurality of sample data including values of a plurality of feature variables and a prediction correct value of the event; and a prediction model generating unit configured to generate a plurality of prediction models using the plurality of training data, to thereby generate a prediction model for calculating an ultimate predicted value on the basis of predicted values of the plurality of prediction models. Prediction models generated by applying the same machine learning algorithm to the plurality of training data are different from each other in features of the event that are reflected in the prediction models.

### CLAIM OF PRIORITY

The present application claims priority from Japanese patent applications JP 2020-150553 filed on Sep. 8, 2020, the content of which is hereby incorporated by reference into this application.

### BACKGROUND OF THE INVENTION

### 1. Field of the Invention

The present invention relates to a technology of machine learning for generating models for predicting events.

### 2. Description of the Related Art

It has been important to increase the prediction accuracy of prediction models for predicting tasks assigned as objective variables. Prediction models are generated by executing machine learning using a plurality of sample data including the values of one or more feature variables (explanatory variables) and one or more objective variables. As elements involving the prediction accuracy of prediction models, for example, the following are generally given: (1) the preparation of training data (data cleansing and the designing of feature variables); (2) the amount of sample data included in training data (as much effective sample data that is not noise as possible is preferably included); and (3) machine learning algorithms to be applied.

JP-2013-164863-A describes the following: “a highly accurate information extracting device construction system includes: a feature extraction expression list generating unit configured to generate a feature extraction expression list; a feature calculating unit configured to calculate a feature of training data with each feature extraction expression; a training data supplying unit configured to supply the training data; an evaluated value calculating unit configured to generate an information extraction expression by machine learning and calculate an evaluated value of each feature extraction expression on the basis of the calculated feature of the training data and the training data; and a synthesis unit configured to construct a highly accurate information extracting device using T weak learners F(X)ₜ and reliability Cₜ corresponding thereto output from the evaluated value calculating unit.”

As in JP-2013-164863-A, prediction models with high prediction accuracy can be generated with ensemble learning in which a plurality of prediction models are generated for training data and the prediction models are integrated to obtain an ultimate predicted value.

Meanwhile, the feature variables of training data include variables having various natures. For example, there are variables having some sort of meaningful values, which are not noise, for most of all sample data included in training data, and variables having meaningful values only for a few of the sample data. The former feature variables indicate the global features of events, while the latter feature variables indicate the local features of events. Herein, feature variables indicating the global features of events are referred to as “global variable,” and feature variables indicating the local features of events are referred to as “local variable.”

When a task is predicting the height of a person from values acquired in a medical checkup, for example, the global variable corresponds to variables indicating age, weight, sex, and the like, while the local variable corresponds to a variable indicating whether he/she meets specific conditions such as whether he/she is a male with a weight of 70 Kg or more.

The local variable indicates conditions that only a few sample data among all sample data may meet, and is often used for the purpose of reflecting analysts' knowledge in prediction models.

In general machine learning, prediction models are trained so that the average of errors between predicted values calculated using the features of sample data and the predicted values of the sample data is small. Thus, depending on the selection of the feature variables of training data, the features of events that are reflected in the prediction models are changed. However, in general, the feature variables of training data often include various feature variables without distinction of global variable from local variable, for example. In this case, there is a tendency that the feature of events obtained from a specific variable (for example, global variable) is strongly reflected, while the features of the events obtained from other variables (for example, local variable) are not reflected.

In the related-art ensemble learning as described in JP-2013-164863-A, a variety in learning algorithm is provided, but a difference in features indicated by feature variables is not paid attention to in learning. Thus, the problem in the related-art ensemble learning that the features of events that are reflected in prediction models are biased is not solved.

The present invention implements, in order to solve the problem that the features of events that are reflected in prediction models are biased, ensemble learning taking a difference in features indicated by feature variables into consideration.

### SUMMARY OF THE INVENTION

A typical example of the invention disclosed in the present application is as follows. That is, there is provided a computer system configured to generate a prediction model for predicting an event, the computer system including: at least one computer including an arithmetic device, a storage device, and a connection interface; a storage unit configured to store a plurality of first training data including a plurality of sample data including values of a plurality of feature variables and a prediction correct value of the event; and a prediction model generating unit configured to generate a plurality of prediction models using the plurality of first training data, to thereby generate a prediction model for calculating an ultimate predicted value based on predicted values of the plurality of prediction models, in which prediction models generated by applying the same machine learning algorithm to the plurality of first training data are different from each other in features of the event that are reflected in the prediction models.

According to the present invention, the ensemble learning taking a difference in features indicated by feature variables into consideration is executed so that the prediction accuracy of prediction models can be enhanced. Problems, configurations, and effects other than those described above will become apparent from the following description of embodiments.

### BRIEF DESCRIPTION OF THE DRAWINGS

FIG. 1 is a diagram illustrating examples of the hardware configuration and software configuration of an information processing device of Embodiment 1;

FIG. 2 is a diagram illustrating an example of the data structure of prediction model management information of Embodiment 1;

FIG. 3 is a flowchart illustrating an example of prediction model generation processing that is executed by the information processing device of Embodiment 1;

FIG. 4A is a diagram illustrating an example of training data of Embodiment 1;

FIG. 4B is a histogram illustrating an example of the distribution of the values of a feature variable included in the training data of Embodiment 1;

FIG. 5A is a diagram illustrating an example of training data of Embodiment 1;

FIG. 5B is a histogram illustrating an example of the distribution of the values of a feature variable included in the training data of Embodiment 1;

FIG. 6A is a diagram illustrating an example of first level training data of Embodiment 1;

FIG. 6B is a diagram illustrating an example of first level training data of Embodiment 1;

FIG. 7 is a diagram illustrating an example of second level training data of Embodiment 1;

FIG. 8 is a diagram illustrating an example of a computer system of Embodiment 2;

FIG. 9 is a diagram illustrating examples of the hardware configuration and software configuration of an information processing device of Embodiment 2; and

FIG. 10 is a diagram illustrating an example of the data structure of first level prediction model management information of Embodiment 2.

### DESCRIPTION OF THE PREFERRED EMBODIMENTS

Now, embodiments of the present invention are described with reference to the drawings. However, the present invention is not interpreted as being limited to the contents of the embodiments described blow. Those skilled in the art can easily understand that the specific configurations may be changed without departing from the spirit or gist of the present invention.

In the configuration of the invention described below, the same or similar configurations or functions are denoted by the same reference numerals, and redundant description is omitted.

The terms such as “first,” “second,” and “third” in this specification and the like are given to identify components, and do not necessarily limit the number or the order.

Data including values corresponding to feature variables (explanatory variables) and a prediction correct value corresponding to an objective variable is herein referred to as “sample data.” The set of sample data including the same feature variables and objective variable is herein referred to as “training data.”

### Embodiment 1

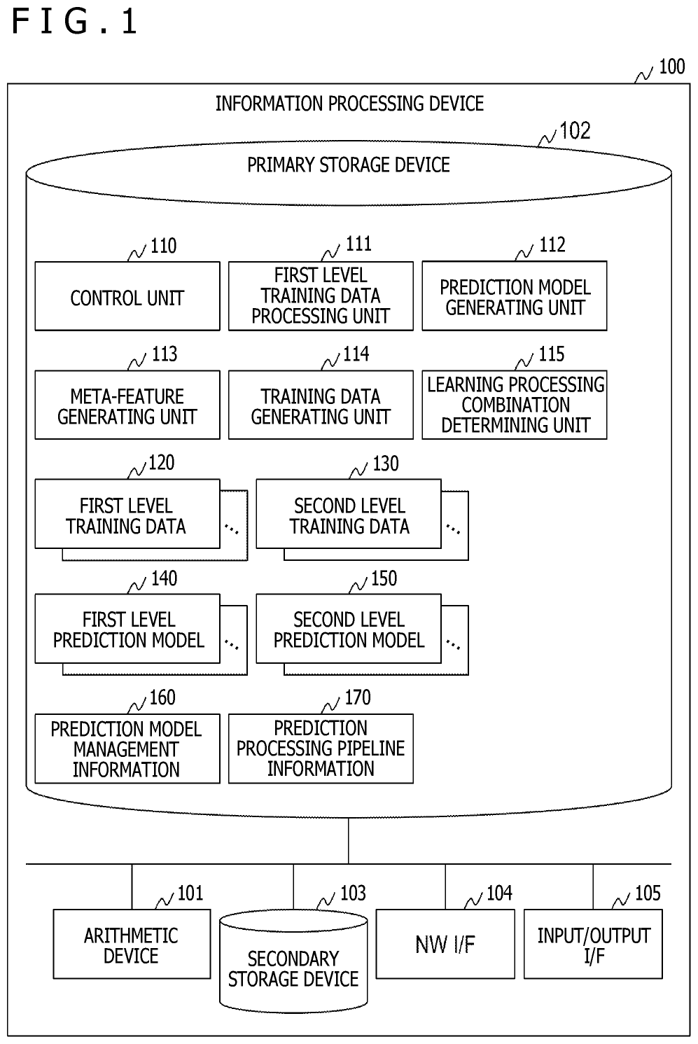

FIG. 1 is a diagram illustrating examples of the hardware configuration and software configuration of an information processing device 100 of Embodiment 1.

The information processing device 100 executes learning processing for generating prediction models using training data. Further, the information processing device 100 applies the prediction models to sample data for prediction to predict events. The information processing device 100 includes, as hardware configurations, an arithmetic device 101, a primary storage device 102, a secondary storage device 103, a network interface 104, and an input/output interface 105. The hardware configurations are connected to each other through an internal bus.

The arithmetic device 101 is a processor, a graphics processing unit (GPU), a field programmable gate array (FPGA), or the like, and executes programs stored in the primary storage device 102. The arithmetic device 101 executes processing on the basis of the programs, to thereby operate as functional units (modules) configured to implement specific functions. In the following, the description given on processing with a subject being a module indicates that the arithmetic device 101 executes a program that implements the module in question.

The primary storage device 102 is a memory such as a dynamic random access memory (DRAM), and stores programs that are executed by the arithmetic device 101 and information that is used by the programs. Further, the primary storage device 102 is also used as a work area that is temporarily used by the programs. Note that, the primary storage device 102 may include a volatile storage element or a nonvolatile storage element. The programs and information that are stored in the primary storage device 102 are described later.

The secondary storage device 103 is a hard disk drive (HDD), a solid state drive (SSD), or the like, and permanently stores data. Note that, programs and information that are stored in the primary storage device 102 may be stored in the secondary storage device 103. In this case, the arithmetic device 101 reads the programs and the information from the secondary storage device 103, and loads the programs and the information into the primary storage device 102 to execute the loaded programs.

The network interface 104 communicates with external devices via a network. The input/output interface 105 is a device for receiving data, such as a keyboard, a mouse, or a touch panel, and is a device such as a display for outputting or displaying data.

The primary storage device 102 stores programs that implements a control unit 110, a first level training data processing unit 111, a prediction model generating unit 112, a meta-feature generating unit 113, a training data generating unit 114, and a learning processing combination determining unit 115. Further, the primary storage device 102 stores first level training data 120, second level training data 130, first level prediction models 140, second level prediction models 150, prediction model management information 160, and prediction processing pipeline information 170. Note that, the information may be stored in the primary storage device 102 when being used in processing and stored in the secondary storage device 103 after the processing has ended.

The first level training data 120 is training data that is used for generating the first level prediction models 140, which are described later. The first level training data processing unit 111 executes the data processing of processing data input to the information processing device 100 or of converting the input data into a predetermined format, to thereby generate the plurality of first level training data 120. The primary storage device 102 of the present embodiment stores the plurality of first level training data 120 different from each other in feature variable.

The second level training data 130 is training data that is used for generating the second level prediction models 150, which are described later. The training data generating unit 114 generates the second level training data 130 including a plurality of sample data including meta-feature variables using the feature variables of the first level training data 120 and feature variables generated by the meta-feature generating unit 113, for example.

The first level prediction models 140 are prediction models generated by applying predetermined learning algorithms to the first level training data 120.

The second level prediction models 150 are prediction models generated by applying predetermined learning algorithms to the second level training data 130. A predicted value output from the second level prediction model 150 is output as an ultimate predicted value.

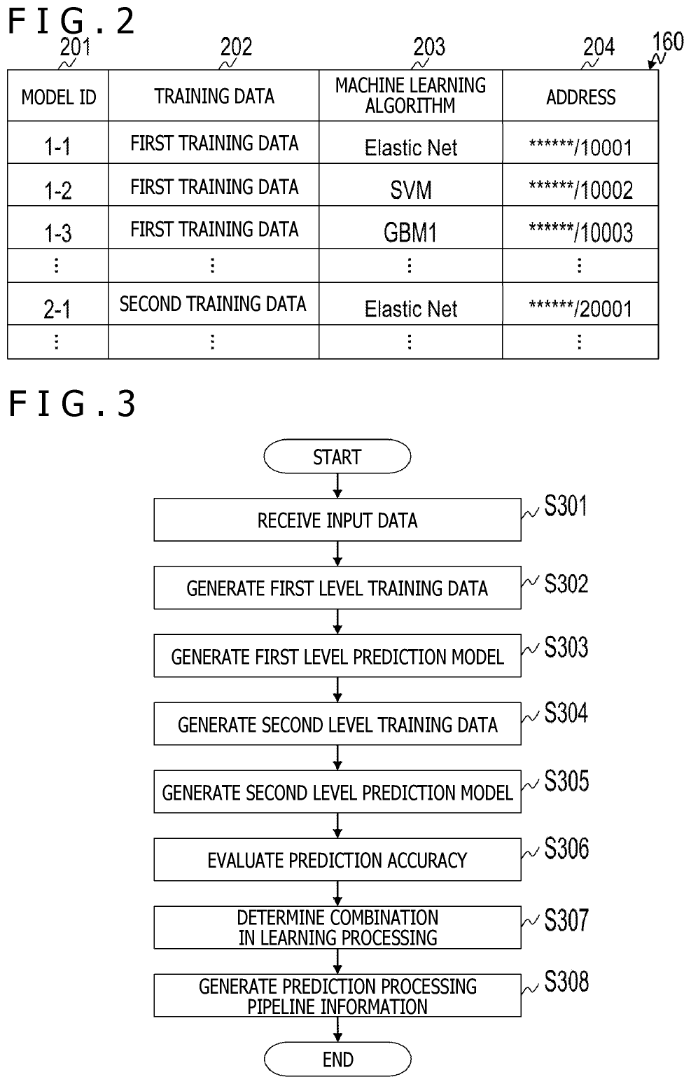

The prediction model management information 160 is information for managing the first level prediction models 140. The details of the data structure of the prediction model management information 160 are described with reference to FIG. 2.

The prediction processing pipeline information 170 is information for managing the processing procedure (pipeline) of prediction processing, such as the types of prediction models and processing methods that are used in prediction processing.

The control unit 110 controls the operation of each module of the information processing device 100.

The first level training data processing unit 111 executes specific data processing on data input to the information processing device 100 to generate the first level training data 120.

The prediction model generating unit 112 applies learning algorithms to training data to generate prediction models for outputting the values of objective variables (predicted values) from the values of optional explanatory variables. The prediction model generating unit 112 generates the first level prediction models 140 using the first level training data 120, and generates the second level prediction models 150 using the second level training data 130.

The meta-feature generating unit 113 generates the values of new feature variables (meta-features) using predicted values obtained by inputting sample data to the first level prediction models 140.

The training data generating unit 114 generates the second level training data 130 from meta-features generated by the meta-feature generating unit 113.

The learning processing combination determining unit 115 performs the processing of determining a combination in learning processing. Here, the combination in learning processing means the combination of the following four.

(1) The details of data processing that is executed on input data to generate the first level training data 120.

(2) Machine learning algorithms and the first level training data 120 used for generating the first level prediction models 140.

(3) Machine learning algorithms used for generating the second level prediction models 150.

(4) The types of meta-features used for generating the second level prediction models 150.

Note that, with regard to each module of the information processing device 100, a plurality of modules may be combined together as a single module or a single module may be divided into a plurality of modules on the basis of the functions. For example, the prediction model generating unit 112 and the learning processing combination determining unit 115 may be combined together as a single unit. Further, the meta-feature generating unit 113 and the training data generating unit 114 may be combined together as a single unit.

FIG. 2 is a diagram illustrating an example of the data structure of the prediction model management information 160 of Embodiment 1.

The prediction model management information 160 stores entries each including a model ID 201, training data 202, a machine learning algorithm 203, and an address 204. The entry is provided for each of the first level prediction models 140.

The model ID 201 is a field for storing IDs unique to the first level prediction models 140. The training data 202 is a field for storing identification information on the used first level training data 120. The machine learning algorithm 203 is a field for storing information on machine learning algorithms used for generating the first level prediction models 140. The machine learning algorithm 203 stores the names of machine learning algorithms, for example. The address 204 is a field for storing addresses indicating the storage locations of the entity data on the first level prediction models 140.

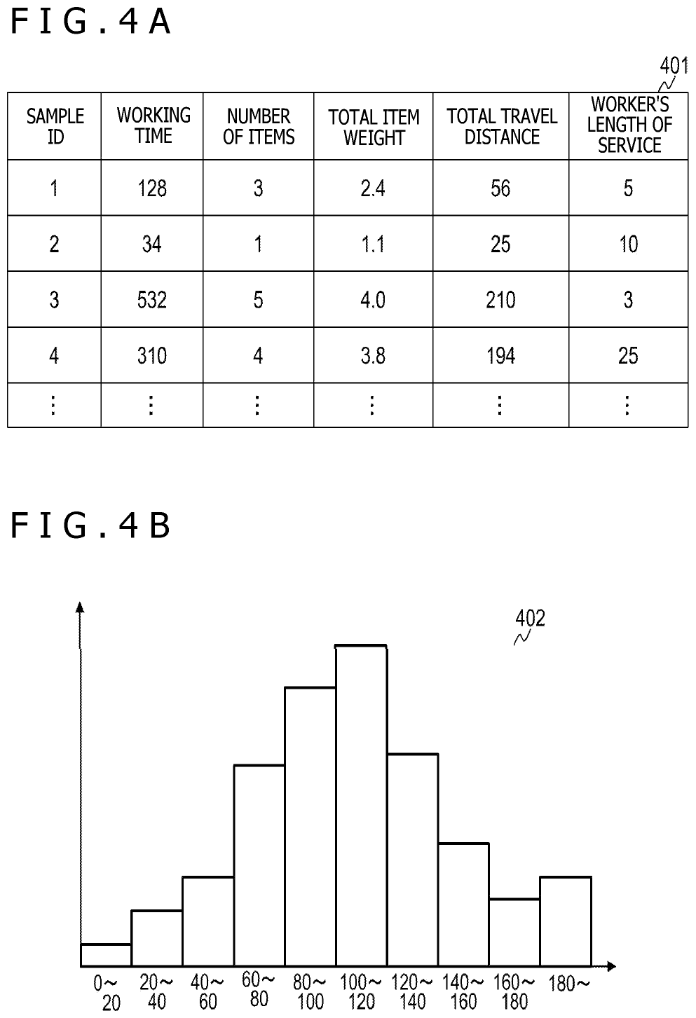

FIG. 3 is a flowchart illustrating an example of prediction model generation processing that is executed by the information processing device 100 of Embodiment 1.

First, the information processing device 100 receives input data (Step S301). At this time, the control unit 110 stores the received input data in the primary storage device 102.

Here, it is assumed that the user has input a plurality of training data having different characteristics as the input data. Here, “training data have different characteristics” means that the features of events (characteristics, tendencies, and the like in prediction) that are reflected in prediction models generated using the same machine learning algorithm are different between training data. More specifically, the feature variables of sample data included in training data are different between the training data. For example, training data including sample data including feature variables having evenly distributed values (global variables), and training data including sample data including feature variables indicating whether data meets specific conditions or not (local variables) are input. Note that, the amount of sample data having meaningful values as local variables is small.

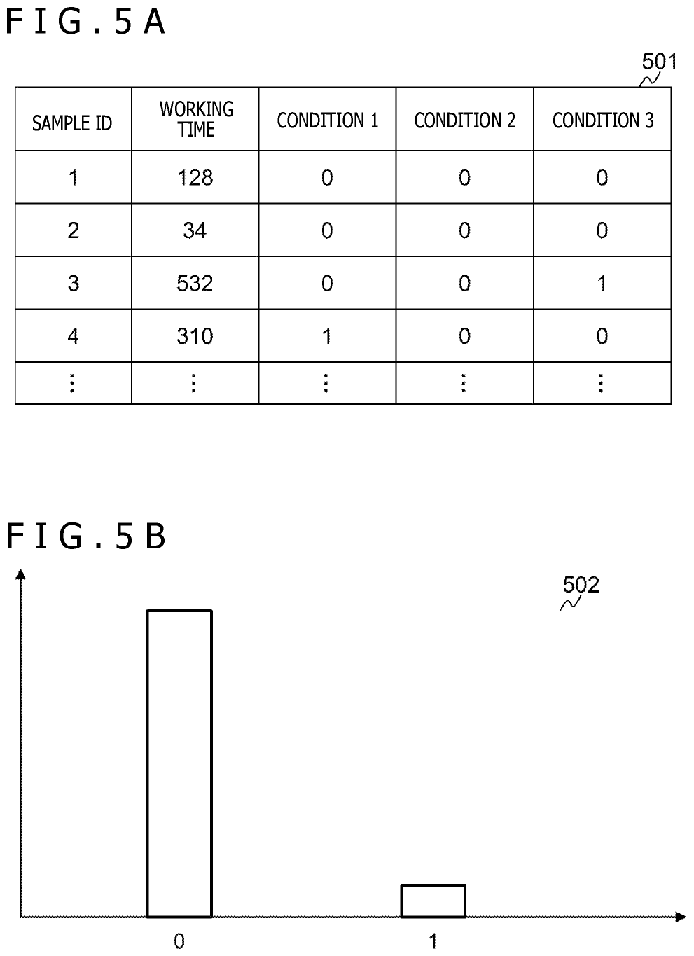

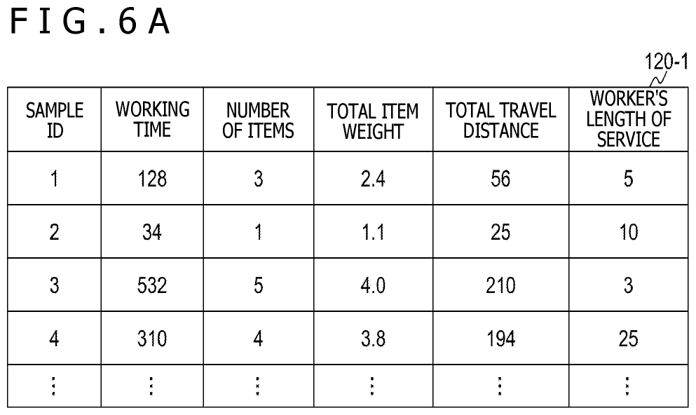

Training data for generating prediction models for predicting the working time required for picking products or items in preparation for shipment in a distribution warehouse is, for example, data as illustrated in FIG. 4A and FIG. 5A. FIG. 4A illustrates an example of training data including sample data including global variables, and FIG. 5A illustrates an example of training data including sample data including local variables.

Training data 401 illustrated in FIG. 4A stores the sample data including sample ID, working time, number of items, total item weight, total travel distance, and worker's length of service.

The sample ID is a field for storing IDs for uniquely identifying sample data. The same ID is given to the same sample data of training data.

The working time is a field corresponding to an objective variable. In the present embodiment, the unit of the working time is “seconds.” The number of items, the total item weight, the total travel distance, and the worker's length of service are fields corresponding to global variables. Any numerical value is stored as each feature variable. FIG. 4B is a histogram 402 illustrating the distribution of the values of the feature variable “total travel distance.” As illustrated in FIG. 4B, global variables indicate information characterizing the natures of sample data.

Note that, the distribution of the values of the global variable is an example, and the present invention is not limited thereto. The distribution of the values of a global variable may be a distribution like the normal distribution as illustrated in FIG. 4B or a biased distribution. In the present embodiment, feature variables having widely distributed values are regarded as “global variable.”

Training data 501 illustrated in FIG. 5A stores sample data including sample ID, working time, Condition 1, Condition 2, and Condition 3. The sample ID and the working time are the same fields as the sample ID and working time of the training data 401. Condition 1, Condition 2, and Condition 3 are fields corresponding to local variables. A value indicating whether data meets the condition or not is stored as each feature variable.

For example, Condition 1, Condition 2, and Condition 3 are the following conditions.

(Condition 1) The worker's length of service is 12 or more and the number of items is 4 or more.

(Condition 2) The total item weight is 2 or less and the number of items is 6 or more.

(Condition 3) The item is on the upper shelf.

Condition 1 and Condition 2 described above are conditions indicating whether or not the values of global features or the combinations of the values correspond to specific ranges. Condition 3 described above is a condition indicating whether data corresponds to specific events or not. In the present embodiment, feature variables indicating whether data corresponds to specific conditions or not are regarded as “local variable.”

FIG. 5B is a histogram 502 illustrating the distribution of the values of the feature variable “Condition 1.” Local variables have a nature as illustrated in FIG. 5B. That is, the values of the local variable of a large amount of sample data are “0” indicating that the data does not meet Condition 1, and only the values of the local variables of a little amount of sample data is “1” indicating that the data meets Condition 1.

Next, the information processing device 100 generates the first level training data 120 using the input data (Step S302).

Specifically, the control unit 110 instructs the first level training data processing unit 111 to generate the first level training data 120. The first level training data processing unit 111 executes predetermined data processing on the input data to generate the plurality of first level training data 120, and stores the plurality of first level training data 120 in the primary storage device 102. At this time, the first level training data processing unit 111 stores some sample data included in each of the first level training data 120 as sample data for evaluation that is used for evaluating the accuracy of prediction models. The sample data in question is not used as sample data for generating the prediction models.

As the data processing, for example, the processing of synthesizing a plurality of different types of training data is conceivable. Specifically, when a sample data group including only global variables (training data 401) and a sample data group including only local variables (training data 501) are input as input data, the first level training data processing unit 111 generates, as the first level training data 120, first training data including sample data including only the global variables, and second training data including sample data including the global variables and the local variables.

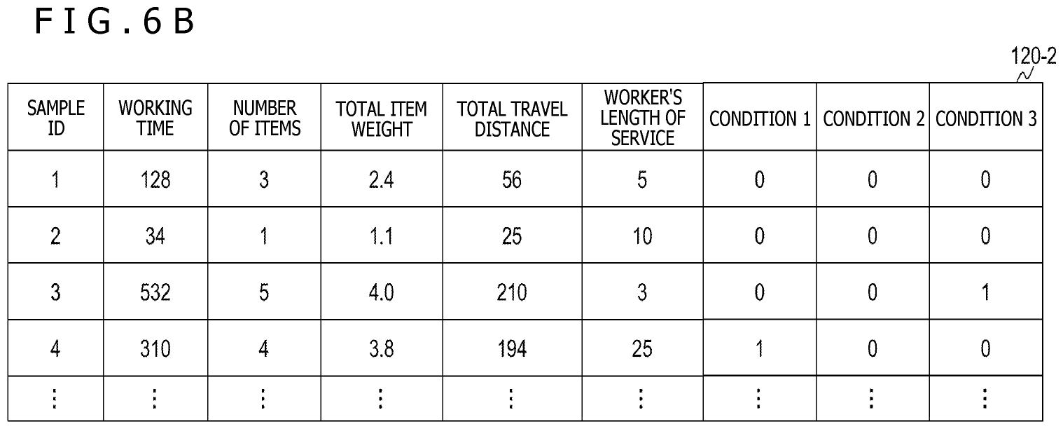

FIG. 6A and FIG. 6B illustrate examples of first level training data 120-1 and 120-2 generated from the training data 401 and 501. As the first level training data 120-1, the training data 401 is stored as it is as the first level training data 120. The first level training data 120-2 is data generated by synthesizing the training data 401 and 501.

In the present embodiment, as illustrated in FIG. 6A and FIG. 6B, the plurality of first level training data 120 having different characteristics are generated.

Note that, the method of generating the first level training data 120 described above is an example, and the present invention is not limited thereto. For example, the first level training data processing unit 111 may directly provide input data as the first level training data 120, or execute data processing different from the above-mentioned data processing to generate the first level training data 120.

Next, the information processing device 100 generates the first level prediction models 140 using the first level training data 120 (Step S303).

Specifically, the control unit 110 instructs the prediction model generating unit 112 to generate the first level prediction models 140. The prediction model generating unit 112 applies a plurality of machine learning algorithms to the first level training data 120, to thereby generate the plurality of first level prediction models 140. The prediction model generating unit 112 stores the plurality of first level prediction models 140 in the primary storage device 102. Further, the prediction model generating unit 112 adds the entries of the first level prediction models 140 to the prediction model management information 160.

Examples of the machine learning algorithms to be applied include linear machine learning algorithms such as elastic net and logistic regression, nonlinear machine learning algorithms such as decision trees, random forests, gradient boosting machines, and deep neural networks, and support vector machines.

Prediction models generated from one training data through the application of different types of machine learning algorithms can be expected to be different from each other in features of events that are reflected therein, in addition to prediction accuracy. Further, also prediction models generated using training data different from each other in feature variable can be expected to be different from each other in features of events that are reflected therein, in addition to prediction accuracy. In this way, the present embodiment has a variety not only in machine learning algorithm, but also in training data, which is a feature.

Next, the information processing device 100 generates the second level training data 130 using the output values of the first level prediction models 140 (Step S304).

Specifically, the control unit 110 instructs the meta-feature generating unit 113 to generate meta-features. The meta-feature generating unit 113 inputs any sample data in the first level training data 120, from which the first level prediction models 140 have been generated, to the first level prediction models 140 to acquire predicted values, and provides the acquired predicted values as meta-features. The control unit 110 instructs the training data generating unit 114 to generate the second level training data 130. The training data generating unit 114 generates the second level training data 130 using the meta-features. Note that, as the objective variable of sample data included in the second level training data 130, for example, the average value of the target variables of sample data included in the first level training data 120 is set. The training data generating unit 114 stores the second level training data 130 in the primary storage device 102.

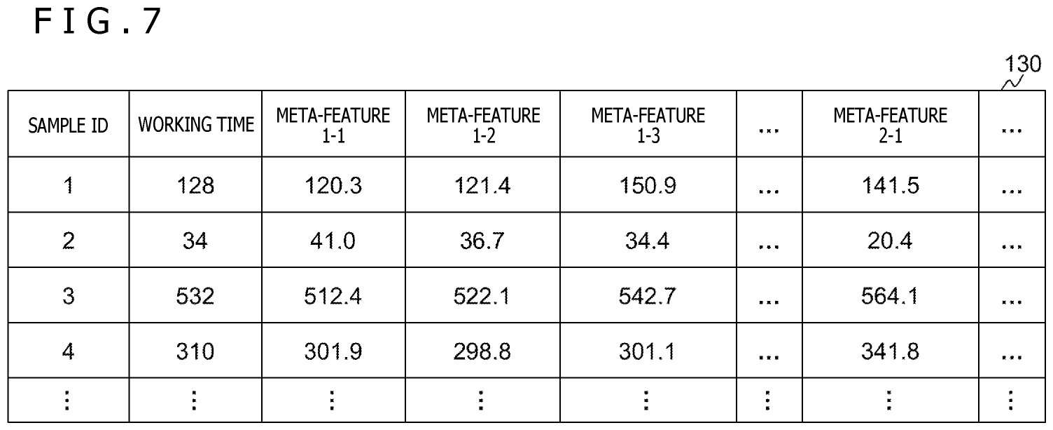

FIG. 7 illustrates an example of the second level training data 130. Sample ID and working time are the same fields as those of the first level training data 120. The remaining fields are fields indicating meta-features. For example, in the “meta-feature 1-1,” predicted values obtained by inputting, to the first level prediction model 140 having “1-1” in the model ID 201, sample data included in the first level training data 120 used for generating the first level prediction model 140 in question are stored.

Next, the information processing device 100 generates the second level prediction models 150 using the second level training data 130 (Step S305).

Specifically, the control unit 110 instructs the prediction model generating unit 112 to generate the second level prediction models 150. The prediction model generating unit 112 applies, to the second level training data 130, any machine learning algorithm selected from available machine learning algorithms, to thereby generate the second level prediction models 150. The prediction model generating unit 112 stores the second level prediction models 150 in the primary storage device 102.

Next, the information processing device 100 evaluates the prediction accuracy of the second level prediction models 150 (Step S306).

Specifically, the control unit 110 instructs the learning processing combination determining unit 115 to evaluate the prediction accuracy. The learning processing combination determining unit 115 inputs the sample data for evaluation to the first level prediction models 140 to calculate predicted values, and inputs data including meta-features generated from the predicted values to the second level prediction models 150. The learning processing combination determining unit 115 evaluates the prediction accuracy on the basis of errors between predicted values obtained from the second level prediction models 150 and the value of the target variable.

The prediction accuracy of prediction processing is evaluated for each machine learning algorithm used to generate the second level prediction models 150. With this, the learning processing combination determining unit 115 can select, on the basis of the evaluation result, a machine learning algorithm suitable for generating the second level prediction models 150, and obtain the second level prediction model 150 with high prediction accuracy.

Next, the information processing device 100 determines a combination in learning processing on the basis of the evaluation result (Step S307).

Specifically, the learning processing combination determining unit 115 determines the combination in learning processing. With this, the single second level prediction model 150 to be used in prediction processing is determined, and the combination of the first level prediction models 140 to be used in prediction processing is also determined. The learning processing combination determining unit 115 generates presentation information for presenting the combination in learning processing to the user. The presentation information output to the user can help the user to understand the learning processing.

Next, the information processing device 100 generates, as the prediction processing pipeline information 170, information on a prediction processing pipeline for calculating predicted values from data to be predicted (Step S308). After that, the information processing device 100 ends the prediction model generation processing.

Here, a specific example of the prediction processing pipeline is described by taking, as an example, prediction processing in a case where data including global variables and local variables is input to be predicted.

In the prediction processing, the following processing is executed. First, the control unit 110 inputs the data to be predicted to the first level prediction models 140 corresponding to the first training data and the second training data to calculate predicted values, that is, meta-features. The control unit 110 generates sample data corresponding to the feature variables of the second level training data 130 using the calculated meta-features, and inputs the sample data to the second level prediction models 150 to calculate an ultimate predicted value.

The learning processing combination determining unit 115 constructs a prediction processing pipeline for implementing the above-mentioned prediction processing, and records the prediction processing pipeline in the primary storage device 102 as the prediction processing pipeline information 170. The prediction processing pipeline information 170 includes the details of data processing for generating the first level training data 120 from input data, the details of processing for generating the second level training data 130, information on the second level prediction models 150, and the like. The information processing device 100 can execute, on the basis of the prediction processing pipeline information 170, prediction processing on data to be predicted, using the prediction models (first level prediction models 140 and second level prediction models 150) generated by learning, which is a feature of the present embodiment.

Next, the variations of input data handling are described.

(Variation 1) In FIG. 3, the case where the first training data and the second training data, which are different types of data, are input as the input data is described as an example, but three or more different types of training data may be input.

In this case, in Step S302, the information processing device 100 generates the three or more first level training data 120. The number of the first level prediction models 140 that are generated in Step S303 is therefore increased. In Step S304, the second level training data 130 is generated from meta-features obtained from the first level prediction models 140. The processing in Step S305 and the subsequent steps are similar to those described above.

With this, prediction models can be generated using training data including sample data including feature variables having features different from global variables and local variables. Examples of the training data to be generated include training data including sample data including feature variables that have a similar nature to local variables but correspond to more sample data than the local variables do. Prediction models incorporating various kinds of user's knowledge can be generated.

(Variation 2) In FIG. 3, the case where the first training data and the second training data, which are different types of data, are input as the input data is described as an example, but only one training data may be input. For example, a case where training data including global variables and local variables is input as input data is conceivable.

As the method of generating the first level training data 120, the following methods are conceivable.

(Method 1) The user inputs information clearly indicating feature variables to be used in learning. As the information specifying the local variables of training data, for example, lists including the names of variables, field numbers, and the like are conceivable.

In Step S302, the information processing device 100 divides and integrates training data on the basis of information received from the user to generate the first level training data 120.

In the case of Method 1, the user uses only one type of input data, and hence the efforts required for input data preparation can be reduced.

(Method 2) The information processing device 100 automatically divides and integrates one type of input data to generate the first level training data 120.

In Step S302, the information processing device 100 determines whether or not each feature variable included in input training data has the characteristic as illustrated in FIG. 5B, or determines whether the distribution of the values of the sample data is biased or not. The information processing device 100 determines whether each feature variable is a local variable or not on the basis of the result of the determination as described above. The information processing device 100 divides and integrates the training data on the basis of the above-mentioned determination result instead of information input by the user, to thereby generate the first level training data 120.

In the case of Method 2, even when the user him/herself does not grasp the characteristics of input data or the like, the information processing device 100 can automatically determine the characteristics of the feature variables, and generate the plurality of first level training data 120 on the basis of the determination result. With this, the first level prediction models 140 having various characteristics can be generated.

(Method 3) The information processing device 100 calculates new feature variables from one training data to generate the first level training data 120.

In Step S302, the information processing device 100 selects, from feature variables included in input training data, feature variables having continuous values. The information processing device 100 calculates the sections of the range of the feature variables. For example, when the range extends from 1 to 90 and the values of the sample data are uniformly distributed, the information processing device 100 calculates three sections of from 1 to 30, from 31 to 60, and from 61 to 90. The information processing device 100 sets the combinations of the sections of the selected feature variables as feature variables indicating conditions (local variables). The information processing device 100 generates sample data including the above-mentioned feature variables, and stores values indicating whether data meets the conditions or not as the feature variables of the sample data.

Note that, when all mechanically generated section combinations are set as local variables, a huge number of local variables are provided. Thus, the information processing device 100 may analyze a relevance (for example, correlation) between an objective variable and the section combinations, and extract only strongly related section combinations as local variables.

In the case of Method 3, new feature variables are generated from input data not including feature variables having different features so that the plurality of types of first level training data 120 can be generated. With this, the first level prediction models 140 having various characteristics can be generated.

Note that, the information processing device 100 may present the result of processing of Method 2 or Method 3 to the user. The examples of the information to be presented to the user include information on feature variables determined as local variables, and the distributions of the values of the local variables of sample data. The information on feature variables includes, for example, the names of variables, standards for sections, or section combinations. This allows the user to grasp the details of feature variables specified as local variables and the distributions of the values thereof, and can thus help the user to understand the learning processing of prediction models.

Note that, the details of processing of generating the first level training data 120 from one input data may be included in the combinations in the learning processing in Step S307 and the prediction processing pipeline information 170 in Step S308. With this, sample data that is automatically input to prediction models can be generated from data to be predicted. Thus, not only in learning processing, but also in prediction processing, the efforts of the user of processing data can be reduced.

Next, the variations of the machine learning algorithm management method are described.

The information processing device 100 may optimize machine learning algorithms to be used for generating the first level prediction models 140, meta-features to be used for generating the second level training data 130, and machine learning algorithms to be used for generating the second level prediction models 150, to thereby increase the prediction accuracy. The following methods are conceivable as the optimization method.

(Optimization 1) In Step S305, the information processing device 100 generates the plurality of second level prediction models 150 through the application of a plurality of machine learning algorithms, and selects the second level prediction model 150 with the highest prediction accuracy.

(Optimization 2) In Step S304, the information processing device 100 selects meta-features to be used for generating the second level training data 130.

When the first level training data 120 are similar to each other, and meta-features generated with the same algorithm do not have much difference in nature, multicollinearity occurs, with the result that the prediction accuracy of the second level prediction models 150 is reduced. In such a case, when meta-features to be used are appropriately selected, a reduction in prediction accuracy of the second level prediction models 150 can be prevented.

The meta-feature selection method may be any method that can prevent the above-mentioned multicollinearity. For example, the information processing device 100 analyzes a correlation between feature variables, and selects only any of the feature variables having high correlation values. Alternatively, the information processing device 100 tries all feature variable combinations.

With Optimization 2, the optimal meta-features for generating the second level training data 130 are selected so that optimization in terms of prediction accuracy can be achieved.

(Optimization 3) In Step S303, the information processing device 100 selects machine learning algorithms to be used for generating the second level prediction models 150.

Specifically, the machine learning algorithms to be used are set in advance, or the machine learning algorithms to be used are set on the basis of input from the user. For example, the user sets the information processing device 100 to apply only GBM to the first training data, and apply all the machine learning algorithms to the second training data.

Note that, machine learning algorithms to be used for generating the second level prediction models 150 may be selected.

Note that, as a mechanism that facilitates the user to specify machine learning algorithms, the following is conceivable. In processing for the first time, the information processing device 100 generates the first level prediction models 140 and the second level prediction models 150 using all the machine learning algorithms, and performs optimization. In Step S307, the information processing device 100 presents a determined combination in learning processing to the user to query whether or not to set the determined combination as the initial value of the combination of machine learning algorithms to be used for next processing.

With Optimization 3, the generation of unnecessary prediction models is prevented so that the processing amount and processing time of the information processing device 100 can be reduced.

Next, the complication and simplification of processing are described.

The generation of prediction models includes the two stages in Embodiment 1, but may include three stages or more. In this case, on the bottom level, prediction models are generated using training data generated by integrating meta-features obtained in the remaining levels.

However, the method of generating prediction models on the intermediate levels may be the method described in Embodiment 1 or another method. For example, meta-features on levels other than the bottom level are integrated on the basis of any prediction model combination on the upper level so that prediction processing using prediction models on the three or more levels can be implemented.

With more levels, a complicated and elaborate combination of prediction models can be implemented, and hence the prediction accuracy can be more enhanced.

The generation of prediction models includes the two stages in Embodiment 1, but may include a single stage. In this case, in prediction, prediction models to be used are switched depending on the contents of data to be predicted.

For example, when data to be predicted includes feature variables corresponding to any of the local feature variables of the second training data, the predicted values of prediction models generated from the second training data are output. Otherwise, the predicted values of prediction models generated from the first training data are output.

With this, prediction models used for input data to be predicted and predicted values are easily grasped so that the interpretability of the prediction models can be increased.

According to Embodiment 1 as described above, prediction models can be generated using training data different from each other in features of events (characteristics and tendencies in prediction) that are reflected in prediction models. This increases the variety of prediction models. The prediction accuracy can be enhanced by stacking the thus generated prediction models.

### Embodiment 2

Embodiment 2 is different from Embodiment 1 in that learning and prediction are executed using a plurality of computers. Now, Embodiment 2 is described mainly in terms of the difference from Embodiment 1 or the like.

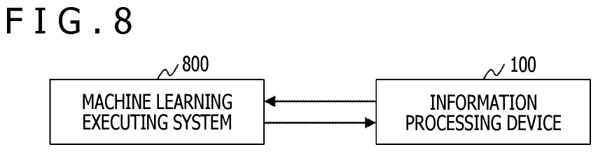

FIG. 8 is a diagram illustrating an example of a computer system of Embodiment 2.

The computer system includes the information processing device 100 and a machine learning executing system 800. The information processing device 100 and the machine learning executing system 800 are connected to each other directly or via a network such as a local area network (LAN).

The machine learning executing system 800 is a system configured to perform learning and prediction in cooperation with the information processing device 100. The machine learning executing system 800 acquires training data from the information processing device 100, and generates prediction models. Moreover, the machine learning executing system 800 acquires data to be predicted from the information processing device 100, and inputs the data to be predicted to the prediction models, to thereby output predicted values.

The machine learning executing system 800 may employ any learning method and machine learning algorithm that allow the machine learning executing system 800 to generate prediction models and output predicted values.

The machine learning executing system 800 may be a cloud system or an on-premises system. In the case where the machine learning executing system 800 is a cloud system, the machine learning executing system 800 may conceal the details of processing in the system from the user, that is, may not receive changes made by the user. In the case where the machine learning executing system 800 is an on-premises system, the machine learning executing system 800 and the information processing device 100 may be provided on the same board or different boards.

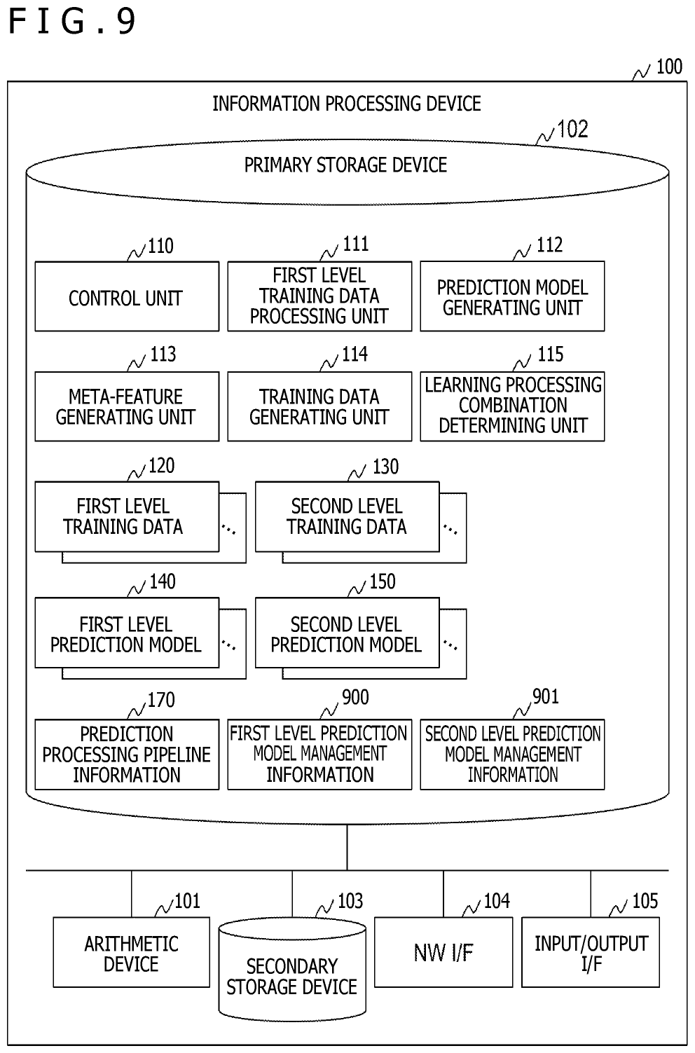

FIG. 9 is a diagram illustrating examples of the hardware configuration and software configuration of the information processing device 100 of Embodiment 2.

The hardware configuration of the information processing device 100 of Embodiment 2 is the same as that of the information processing device 100 of Embodiment 1, and hence the description thereof is omitted. The information processing device 100 of Embodiment 2 is partly different from that of Embodiment 1 in software configuration. Specifically, the primary storage device 102 stores first level prediction model management information 900 and second level prediction model management information 901.

The first level prediction model management information 900 is information for managing the first level prediction models 140, and the second level prediction model management information 901 is information for managing the second level prediction models 150.

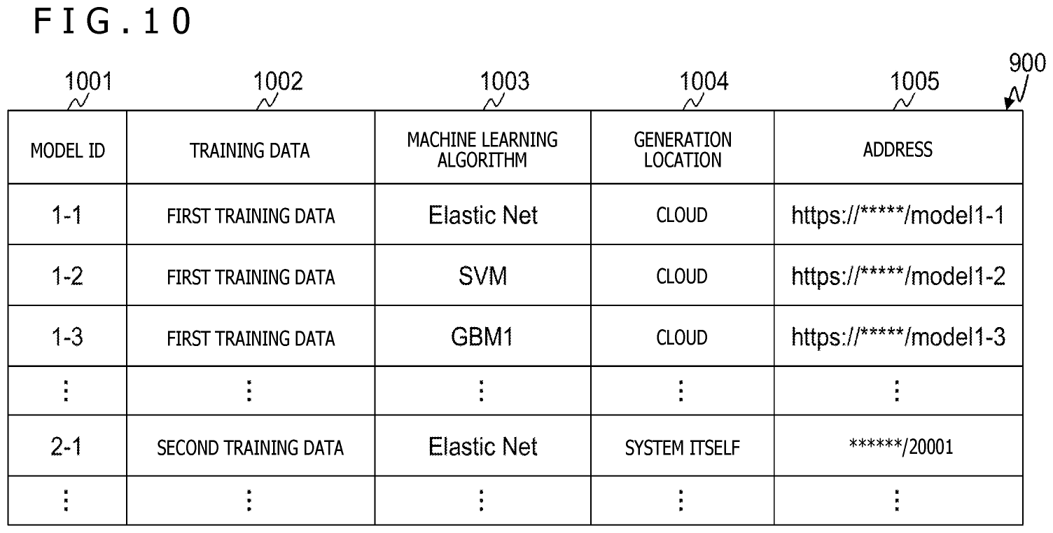

FIG. 10 is a diagram illustrating an example of the data structure of the first level prediction model management information 900 of Embodiment 2.

The first level prediction model management information 900 stores entries each including a model ID 1001, training data 1002, a machine learning algorithm 1003, a generation location 1004, and an address 1005. The entry is provided for each of the first level prediction models 140.

The model ID 1001, the training data 1002, and the machine learning algorithm 1003 are the same fields as the model ID 201, the training data 202, and the machine learning algorithm 203.

The generation location 1004 is a field for storing information indicating systems in which the first level prediction models 140 have been generated. In the present embodiment, “system itself” is stored in the generation location 1004 for the first level prediction models 140 generated by the information processing device 100, and “cloud” is stored in the generation location 1004 for the first level prediction models 140 generated by the machine learning executing system 800.

The address 1005 is a field for storing addresses or URLs indicating the storage locations of the entity data on the first level prediction models 140. Addresses in the system itself are stored in the address 1005 for the first level prediction models 140 generated by the information processing device 100, and the URLs of web API or the like are stored in the address 1005 for the first level prediction models 140 generated by the machine learning executing system 800.

The second level prediction model management information 901 may have the same data structure as the first level prediction model management information 900 has or a data structure including only the model ID 1001, the generation location 1004, and the address 1005.

Next, learning and prediction of Embodiment 2 are described. First, the learning of Embodiment 2 is described.

Step S301 and Step S302 are the same processing as those of Embodiment 1.

In Step S303, the information processing device 100 instructs at least one of the prediction model generating unit 112 and the machine learning executing system 800 to generate the first level prediction models 140.

In the case where the machine learning executing system 800 is instructed to generate the first level prediction models 140, a generation instruction including the first level training data 120 to be used is transmitted to the machine learning executing system 800. In this case, the information processing device 100 receives, from the machine learning executing system 800, a response including the URLs of the first level prediction models 140 or the like.

For example, the following is conceivable: the machine learning executing system 800 is set to process the first training data and the system itself is set to process the second training data. That is, the machine learning executing system 800 processes training data that is less likely to be largely changed in designing feature variables, and the system itself processes training data that is likely to be largely changed in designing feature variables. With this, while the resource usage of cloud systems (for example, usage of pay-as-you-go systems) is reduced, the most effective local variables can be designed with the application of the processing of the present invention.

Note that, the first level training data 120 that is learned by the machine learning executing system 800 may be specified by the user or set as default.

In Step S304, the information processing device 100 transmits, with regard to the first level prediction models 140 generated by the machine learning executing system 800, an output instruction including the address 1005 of the first level prediction model management information 900 and the first level training data 120. The information processing device 100 receives predicted values calculated by the machine learning executing system 800 as a response, and stores the predicted values as meta-features.

In Step S305, the information processing device 100 instructs at least one of the prediction model generating unit 112 and the machine learning executing system 800 to generate the second level prediction models 150.

In the case where the machine learning executing system 800 is instructed to generate the second level prediction models 150, a generation instruction including the second level training data 130 to be used is transmitted to the machine learning executing system 800. In this case, the information processing device 100 receives, from the machine learning executing system 800, a response including the URLs of the second level prediction models 150 or the like.

Note that, information such as the values of local variables desired not to be open to the public may be processed inside the system itself. In the present embodiment, the information processing device 100 eventually integrates meta-features.

According to Embodiment 2, the information processing device 100 can perform learning and prediction in cooperation with another system. With this, advanced learning processing can be implemented using cloud systems having a wealth of computer resources. Further, prediction models are generated in a distributed manner so that the processing load can be balanced and the processing speed can be increased.

Note that, the present invention is not limited to the embodiments described above, and includes various modified examples. Further, for example, the above-mentioned embodiments are described in detail regarding the configurations in order to clearly describe the present invention, and are not necessarily limited to including all the configurations described. Further, a part of the configuration of each embodiment can be deleted or can be added to or replaced with the other configurations.

Further, the respective configurations, functions, processing units, processing means, or the like described above may be implemented by hardware, for example, of which some or all are designed into an integrated circuit. Further, the present invention can also be implemented by the program codes of software for implementing the functions of the embodiments. In this case, a storage medium storing the program codes is provided to a computer, and a processor included in the computer reads the program codes stored in the storage medium. In this case, the program codes themselves, which have been read from the storage medium, implement the functions of the embodiments described above, and the program codes themselves and the storage medium storing the program codes form the present invention. Examples of the storage medium for supplying such program codes include flexible disks, compact disc read only memories (CD-ROMs), digital versatile disc read only memories (DVD-ROMs), hard disks, SSDs, optical discs, magneto-optical disks, compact disc-recordables (CD-Rs), magnetic tapes, nonvolatile memory cards, and ROMs.

Further, the program codes that implement the functions described in the present embodiments can be implemented in a wide range of programs or scripting languages, for example, assembler, C/C++, perl, Shell, PHP, Python, and Java (registered trademark).

Moreover, the software program codes that implement the functions of the embodiments may be distributed via a network to be stored in storage means such as a hard disk or memory of a computer or a storage medium such as a compact disc-rewritable (CD-RW) or a CD-R, and a processor included in the computer may read and execute the program codes stored in the storage means or the storage medium.

In the above-mentioned embodiments, control lines and information lines that are considered to be necessary for the description are described, and all the control lines or information lines of a product are not necessarily described. All the configurations may be connected to each other.

What is claimed is:

1. A computer system configured to generate a prediction model for predicting an event, the computer system comprising:
at least one computer including an arithmetic device, a storage device, and a connection interface;
a storage unit configured to store a plurality of first training data including a plurality of sample data including values of a plurality of feature variables and a prediction correct value of the event; and
a prediction model generating unit configured to generate a plurality of prediction models using the plurality of first training data, to thereby generate a prediction model for calculating an ultimate predicted value based on predicted values of the plurality of prediction models, wherein
prediction models generated by applying a same machine learning algorithm to the plurality of first training data are different from each other in features of the event that are reflected in the prediction models.

2. The computer system according to claim 1, wherein
the prediction model generating unit is configured to
apply a plurality of machine learning algorithms to the respective plurality of first training data, to thereby generate a plurality of first level prediction models,
generate second training data including a plurality of sample data including meta-features calculated from predicted values of the plurality of first level prediction models, and the prediction correct value of the event, and
apply a machine learning algorithm to the second training data, to thereby generate a second level prediction model for outputting the ultimate predicted value of the event.

3. The computer system according to claim 2, wherein
the plurality of first training data include
training data for generating the prediction models in which a global feature of the event is reflected, and
training data for generating the prediction models in which a local feature of the event is reflected.

4. The computer system according to claim 2, further comprising:
a training data generating unit configured to
receive input data including a plurality of data including values of a plurality of variables, and information indicating the feature variables of the sample data included in the respective plurality of first training data, and
generate the plurality of first training data from the input data on a basis of the information.

5. The computer system according to claim 2, further comprising:
a training data generating unit configured to
receive input data including a plurality of data including values of a plurality of variables,
analyze the plurality of variables of the data included in the input data, and
generate the plurality of first training data from the input data on a basis of a result of the analysis.

6. The computer system according to claim 2, wherein
the prediction model generating unit is configured to
evaluate prediction accuracy of the second level prediction model,
generate, based on a result of the evaluation of the prediction accuracy of the second level prediction model, presentation information for presenting a combination of the meta-features to be used for training the second level prediction model and a type of the machine learning algorithm to be applied to the second training data that achieve a highest prediction accuracy, and
output the presentation information.

7. The computer system according to claim 5, wherein
the prediction model generating unit generates, as information to be used for prediction processing that is executed when data to be predicted is input, prediction processing pipeline information including details of processing for generating the first training data from the input data, details of processing for generating the second training data, and information on the second level prediction model.

8. The computer system according to claim 2, wherein
a plurality of the computers each include the prediction model generating unit.

9. An information processing method for generating a prediction model for predicting an event, executed by a computer system including at least one computer including an arithmetic device, a storage device, and a connection interface, the information processing method comprising:
by the arithmetic device, a first step of storing, in the storage device, a plurality of first training data including a plurality of sample data including values of a plurality of feature variables and a prediction correct value of the event; and
by the arithmetic device, a second step of generating a plurality of prediction models using the plurality of first training data and generating a prediction model for calculating an ultimate predicted value based on predicted values of the plurality of prediction models, wherein
prediction models generated by applying a same machine learning algorithm to the plurality of first training data are different from each other in features of the event that are reflected in the prediction models.

10. The information processing method according to claim 9, wherein
the second step includes,
by the arithmetic device, applying a plurality of machine learning algorithms to the respective plurality of first training data and generating a plurality of first level prediction models, and storing the plurality of first level prediction models in the storage device,
by the arithmetic device, generating second training data including a plurality of sample data including meta-features calculated from predicted values of the plurality of first level prediction models, and the prediction correct value of the event, and storing the second training data in the storage device, and
by the arithmetic device, applying a machine learning algorithm to the second training data and generating a second level prediction model for outputting the ultimate predicted value of the event, and storing the second level prediction model in the storage device.

11. The information processing method according to claim 10, wherein
the plurality of first training data include
training data for generating the prediction models in which a global feature of the event is reflected, and
training data for generating the prediction models in which a local feature of the event is reflected.

12. The information processing method according to claim 10, wherein
the first step includes,
by the arithmetic device, receiving input data including a plurality of data including values of a plurality of variables, and information indicating the feature variables of the sample data included in the respective plurality of first training data, and
by the arithmetic device, generating the plurality of first training data from the input data on a basis of the information, and storing the plurality of first training data in the storage device.

13. The information processing method according to claim 10, wherein
the first step includes,
by the arithmetic device, receiving input data including a plurality of data including values of a plurality of variables,
by the arithmetic device, analyzing the plurality of variables of the data included in the input data, and
by the arithmetic device, generating the plurality of first training data from the input data on a basis of a result of the analysis, and storing the plurality of first training data in the storage device.

14. The information processing method according to claim 10, further comprising:
by the arithmetic device, evaluating prediction accuracy of the second level prediction model;
by the arithmetic device, generating, based on a result of the evaluation of the prediction accuracy of the second level prediction model, presentation information for presenting a combination of the meta-features to be used for training the second level prediction model and a type of the machine learning algorithm to be applied to the second training data that achieve a highest prediction accuracy; and
by the arithmetic device, outputting the presentation information.

15. The information processing method according to claim 13, further comprising:
by the arithmetic device, generating, as information to be used for prediction processing that is executed when data to be predicted is input, prediction processing pipeline information including details of processing for generating the first training data from the input data, details of processing for generating the second training data, and information on the second level prediction model; and
by the arithmetic device, storing the prediction processing pipeline information in the storage device.
